(19) United States
(12) Patent Application Publication
(10) Pub. No.: US 2007/0217885 A1
(43) Pub. Date: Sep. 20, 2007

(54) Special reusable anchor

(76) Inventor: Robert Martinez, McCordsville, IN (US)

Correspondence Address: RITCHISON LAW OFFICES, PC;John D. Ritchison, Suite A, 115 East Ninth Street, Anderson, IN, 46016-1509, US

(21) Appl. No.: 11/647,856

(22) Filed: Dec. 29, 2006

Related U.S. Application Data
(60) Provisional application No. 60/778,655, filed on Mar. 3, 2006.

(51) Int. Cl. F16B 13/04

(52) U.S. Cl. 411/75

(57) ABSTRACT

A special anchoring device called a SPECIAL REUSABLE ANCHOR. This device is used to mount and secure various objects to a structure of masonry, concrete, wood, metal, gypsum wallboard, and the like. After the secure connection or attachment, the device may be released and reused if desired. This removal does not damage or weaken the structure or anchor device. The device is comprised of several structural members namely a fastener with various top portions or “heads”; a free wedge portion with a non-threaded aperture; and, a threaded wedge means for securing and connecting the SPECIAL REUSABLE ANCHOR to a structure. While the three main members are securely connected to the structure, the overall device has a means to release and reuse the SPECIAL REUSABLE ANCHOR for other connections without significant damage to the structure.

### CROSS-REFERENCE TO RELATED APPLICATIONS

This application claims the benefit of Provisional Patent Application Ser. No. 60/778,655 filed Mar. 3, 2006 by Robert Martinez and titled “SPECIAL REUSABLE ANCHOR”.

### FIELD OF INVENTION

This invention relates to SPECIAL REUSABLE ANCHORS and the like. Particularly this anchor device is related to special anchor devices that have a releasable configuration. This configuration permits the anchor to first provide a secure attachment or connection and then afterward to be released, unsecured and then to be re-used, if desired.

### FEDERALLY SPONSORED RESEARCH

None.

### SEQUENCE LISTING OR PROGRAM

None.

### BACKGROUND—FIELD OF INVENTION AND PRIOR ART

The new SPECIAL REUSABLE ANCHORS and the like described in this specification is an anchoring mechanism that is designed to have a releasable configuration.

A. Introduction of the Problems Addressed

Traditionally, the anchoring devices to date are not re-useable or easily releasable after the initial installation. Often, the anchor devices are destroyed when they are removed from operation. The present device addresses these short-falls in anchor systems as will be demonstrated below.

B. Prior Art

The historical technology focused mainly on anchor systems that were not re-usable or easily installed. Several devices have attempted to address anchor systems with limited success. However, for the problems as stated the prior art devices were often complex, difficult to install and limited in use. The advantages and objectives of the new SPECIAL REUSABLE ANCHORS is well stated below in detail. This new device addresses these limitations and provides a solution to the stated problems.

Examples of prior anchor devices begin with U.S. Pat. No. 683,082 issued to J. C. Summerer (1901). This invention teaches a plurality of pieces in a complex configuration to provide an anchor by means of an expandable shell or outer collar. The inner reversely arranged sleeves have protrusions and internal threads that engage with the external thread of the ordinary bolt. The engagement to the sleeves by the bolt forces the outer shell to engage the hole. The device has several more parts and requires more complex manufacturing than the SPECIAL REUSABLE ANCHORS. It does not appear as re-useable as the new SPECIAL REUSABLE ANCHORS configuration presented here. Next, is U.S. Pat. No. 1,429,298 issued to H. W. Pleister (1922) which teaches a bolt anchor. The new process of using sheet rolled into a cylinder and then machined to be a part of the many parts is an improvement over cast counter-types of anchors. The complex unit is not reusable or easily removed. Therefore it has several limitations when compared with the new SPECIAL REUSABLE ANCHORS configured by the applicant Martinez.

A further example of a construction anchor is shown by R. J. Ernst in U.S. Pat. No. 5,653,563 (1997). This teaches a casting with complex configurations including a dust and debris cap as well as designed configurations for the portion to deform during use. The invention is essentially destroyed upon use. The designed portions of the anchor portion has various geometric shapes which will increase the production cost of the non-reusable anchor. The anchor is adapted to be inserted, anchoring portion first into a pre-drilled adhesive-filled hole. Another cost increase compared with the present new SPECIAL REUSABLE ANCHORS. A REMOVABLE ANCHOR ASSEMBLIES is taught by J. H. Walsh in U.S. Pat. No. 4,259,890 (1981). This teaches a removable anchor assembly has an elongated hollow tube including integral upper and lower portions with at least the lower portion exhibiting resilience to lateral deflection of segments of the walls thereof. The lower portion normally changes in a diameter progressively from near the junction with the upper portion, and the upper portion generally has predetermined internal and external diameters. The tube has longitudinal slots and the assembly has a rigid plug that is movable through the upper portion of the tube. The plug later may be engaged so as to permit its withdrawal and consequent contraction of the ridge in an amount to enable removal of the anchor from an opening in which it has been secured. The unit is essentially not re-useable.

In the U.S. Pat. No. 1,798,273 (1931), H. W. Pleister taught an expansion “nail” which collapsed and expanded when driven into the solid wall. The unit was simple, yet not easily removed and not re-useable. Another U.S. Pat. No. 4,906,149 (1990) by Rockenfeller, et al shows a WALL PLUG ANCHOR ASSEMBLY FOR MOUNTING IN A PREFORMED HOLE. This device included a deformable sleeve, a wedge, a sphere, and a drivable dowel. The sleeve deformed under the pressure of the wedge, ball and dowel and expanded and mechanically pressed into the accepting aperture. The unit has limited point of contact between the anchor and the receiving aperture and is not reusable.

Another U.S. Pat. No. 5,123,791 (1992) by Rockenfeller, et al shows a Rock Anchor consisting of a drive pin, a sleeve and a wedge. The unit is fairly simple, yet essentially not reusable as the sleeve is permanently deformed during initial use and removal is difficult at best compared with the new SPECIAL REUSABLE ANCHORS. A very complex expansion insert is taught by W. F. Herod in the U.S. Pat. No. 2,028,328 (1936). The mechanism is very complex machined parts with expanding “wedges”. The purported use is for casters and the like and is not for inexpensive, reusable purposes such as the new SPECIAL REUSABLE ANCHORS. The cost to produce the taught device appears excessive in comparison to the new device taught herein.

An example of a tube coupler is taught by U.S. Pat. No. 2,214,177 (1939) in which F. J. Raybold demonstrates a method to join round tubes. The mechanism is a series of precision machined parts that engage and expand the seals against the interior walls of the tubes. The expansion is essentially uniform for an expansible ring on an inner collar. The devices are not shown or claimed to be re-usable. A similarly expanding device is demonstrated in the U.S. Pat. No. 2,850,308 (1958) granted to A. L Le Febvre et al. This expanding device was a machined mechanism used to lock telescoping tubes into place. The configuration was re-useable yet the actual holding power was not described or claimed significant to be used as an anchor as shown in the new SPECIAL REUSABLE ANCHORS.

An examples of a wedge lock for a keyway is shown by U.S. Pat. No. 3,528,691 (1969) granted to T. G. Matich, Jr. This mechanical device engages two inclined plane “blocks” by means of threaded pins. As the pins are engaged and shortened by turning, the inclined planes move toward a common point and the upper and lower surfaces move away from each other. The result is an expanded mechanism in a keyway that clamps the adjacent surface in the keyway and grips the adjacent member. PLUG CONNECTIONS FOR VERICALLY ABUTTING FRAME SECTIONS are shown in the U.S. Pat. No. 3,867,048 (1975) issued to A. Endzweig. The device teaches a plug connector for joining together frame sections comprising a bar which has a recess in at least one end of it. A screw bolt, spring and pin are configured to help engage and secure the connected pieces. A biasing means is mounted about the screw bolt and positioned between the cross wall and an auxiliary pusher means. The enlarged head of the screw bolt is fitted into a hole and slot-arrangement in the member being joined, and then the bar is rotated in a given direction so as to screw the screw bolt inwardly thereby making a solid joint. The overall design has more parts and a relatively more expensive design than the new SPECIAL REUSABLE ANCHORS.

U.S. Pat. No. 5,232,304 (1993) issued to T. Huang teaches a connector for hollow pipes. This connector structure for pipes comprises a connecting rod, a side stop, a connecting block, and a slidable fixing block with a slope opposite the slope of the connecting block. A plug unit is in the receiving pipe and the slidable device in the connecting pipe. The mechanical means does not anticipate the simplistic and fewer part design accomplished by the new SPECIAL REUSABLE ANCHORS. A clamping device is demonstrated by U.S. Pat. No. 5,464,299 (1995) which was issued to P. Schaer et al. This clamping device can be anchored in a hollow profile member by expansion in force-derived fashion comprises two wedge-like wedge sleeve halves. A surface responsible for the force-derived connection is constituted at least in part by a coating of granulated hard material. The connection has several more pieces and a more complex design than the present new SPECIAL REUSABLE ANCHORS. The device shows an inclined plane configuration with a more complex engagement than the present device.

U.S. Pat. No. 6,203,239 (2001) was issued to D. Mucciaccciaro et al. This describes a WEDGE PLUG TUBING CONNECTOR. The inclined planes and coupling surfaces show and claim tubular connections. There are no “anchor” means performed onto other surfaces or member couplings as described by the present, new SPECIAL REUSABLE ANCHORS. A joint connects one end of a tube to the side of a hollow member. It employs a pair of wedge elements that have sloping sides. A threaded fastener passes freely through a proximal wedge and then is threaded through a distal wedge. The fastener first passes through a hole in the side of the member and the wedges are inserted into the end of the tube. Joints shown are for tubes with various shapes, but flat plane anchoring is not taught, claimed or anticipated.

As far as known, there are no releasable and reusable anchor devices at the present time which fully meet this need with as few components and superior operation as the present SPECIAL REUSABLE ANCHOR device. It is believed that this device is made with fewer parts, of a more durable design, and with much improved connection and attachment capabilities than any previous anchor devices.

### SUMMARY OF THE INVENTION

A SPECIAL REUSABLE ANCHOR has been developed for use by a person to mount and secure objects to a structure of masonry, concrete, wood, metal, gypsum wallboard, and the like. After the secure connection or attachment, the SPECIAL REUSABLE ANCHOR may be released and reused if desired. Traditionally, anchor devices are not easily removable or reusable. The anchor devices are often destroyed when they are removed from the structures. This removal normally leaves the structure itself damaged and weakened from the removal. Specifically, the SPECIAL REUSABLE ANCHOR provides a device that may be easily used to secure an object, then easily removed for re-use.

The preferred embodiment of the device is comprised of several structural members namely a fastener with various top portions or “heads”; a free wedge portion with a non-threaded aperture; and, a threaded wedge means for securing and connecting the SPECIAL REUSABLE ANCHOR to a structure. While the three main members are securely connected to the structure, the overall device has a means to release and reuse the SPECIAL REUSABLE ANCHOR for other connections without significant damage to the structure.

The newly invented SPECIAL REUSABLE ANCHOR device features mostly common, readily available parts. In operation, the new SPECIAL REUSABLE ANCHOR device may be assembled and operated with common fasteners and tools.

### OBJECTS AND ADVANTAGES

There are several objects and advantages of the SPECIAL REUSABLE ANCHOR device. There currently exist few mechanisms that permit a secure connection that also permits release and re-use.

One advantage and object of the present invention is that is re-usable. This means the SPECIAL REUSABLE ANCHOR can be used by a person to securely attach one structure or member to another structure or member and then later release and disconnect the two structures. The wedge devices permit the anchor to engage into the aperture as the fastener is tightened. Later, the fastener is easily released and the anchor removed. Another advantage is that the device is non-destructive. It may be removed such that the only evident remains is the hole or aperture placed in the receiving object or structure. This aperture may easily be filled with a putty or other filler to disguise the hole aesthetically.

Another advantage and object for the SPECIAL REUSABLE ANCHOR device is to provide a device that is a combination of simple mechanisms. The components of the device are simple parts that may be easily manufactured and provide an economy of scale. The manufacturing processes to machine and/or mold the individual components of the SPECIAL REUSABLE ANCHOR are readily known by one skilled in the art or anchor and fastening devices.

Another object of the present invention to be durable and strong when used. The engagement feature of the wedge components of the SPECIAL REUSABLE ANCHOR provides significant improvements in anchoring a structure or member to another structure.

A further advantage for the SPECIAL REUSABLE ANCHOR is the various angle interfaces. A two wedge system functions well. Additional members may be stacked to achieve more interference and engagement and thereby provide added retention forces. The retention capability is then only a function of thickness of the receiving structure and/or number of SPECIAL REUSABLE ANCHOR used in the connection scheme. Another advantage is that the SPECIAL REUSABLE ANCHOR is essentially adaptable to most other current connection protocol. This means the SPECIAL REUSABLE ANCHOR is interchangeable and easily replaces many of the “non-re-useable” anchors currently available in the market.

Finally, other advantages and additional features of the present SPECIAL REUSABLE ANCHOR device will be more apparent from the accompanying drawings and from the full description of the device. For one skilled in the art of anchor devices and such, it is readily understood that the features shown in the examples with this mechanism are readily adapted to other types of anchor and connector improvements.

### DESCRIPTION OF THE DRAWINGS—FIGURES

The accompanying drawings, which are incorporated in and constitute a part of this specification, illustrate an embodiment of the SPECIAL REUSABLE ANCHOR device that is preferred. The drawings together with the summary description given above and a detailed description given below serve to explain the principles of the SPECIAL REUSABLE ANCHOR device. It is understood, however, that the SPECIAL REUSABLE ANCHOR device is not limited to only the precise arrangements and instrumentalities shown.

FIGS. 1A and B are Photographs of a prototype assembly of the SPECIAL REUSABLE ANCHOR device 31.

FIG. 2A through 2D are photographs of the SPECIAL REUSABLE ANCHOR device 31 with the various components noted.

FIG. 3A through 3E are photographs of the SPECIAL REUSABLE ANCHOR device 31 with the various components of the anchor noted.

FIGS. 4A through 4D are examples of the SPECIAL REUSABLE ANCHOR 31 in various configurations.

FIGS. 5A and B are photographs of an alternative embodiment of the SPECIAL REUSABLE ANCHOR 31 and its components.

FIG. 6 is a photograph of additional alternative embodiments of the SPECIAL REUSABLE ANCHOR 31.

FIG. 7 is another photograph showing the additional alternative embodiments of the SPECIAL REUSABLE ANCHOR 31.

FIG. 8 is a photograph showing the detailed components for the two piece and three piece wedges for the SPECIAL REUSABLE ANCHOR 31.

FIGS. 9A and B are photographs of the SPECIAL REUSABLE ANCHOR 31 as the wedges are engaged.

FIGS. 10A through E are photographs of a SPECIAL REUSABLE ANCHOR 31 with an eyelet showing attachment to a wood structure.

FIGS. 11A through F are photographs of a SPECIAL REUSABLE ANCHOR 31 with a hex head bolt showing attachment to a wood structure.

FIGS. 12A through C are photographs of the preferred embodiment of the SPECIAL REUSABLE ANCHOR device 31 in its full operation.

FIGS. 13A, 13B, and 13C are close-up photographs of the SPECIAL REUSABLE ANCHOR 31 in operation.

FIGS. 14A through 14D are photographs of an operation of an embodiment for a SPECIAL REUSABLE ANCHOR 31 attached to a wood structure.

FIG. 15 is a photograph of a SPECIAL REUSABLE ANCHOR 31 supporting a concrete structure.

FIGS. 16A through 14C are photographs of an operation of an embodiment for a SPECIAL REUSABLE ANCHOR 31 attached to a metal structure.

FIGS. 17A through 17C are photographs of an operation of an embodiment for a SPECIAL REUSABLE ANCHOR 31 attached to a wood structure on a door and door support.

FIGS. 18A through 18C are photographs of an operation of an embodiment for a SPECIAL REUSABLE ANCHOR 31 attached to a wood structure on a door cross support.

FIGS. 19A through 19C are sketches replicating photographs of pressure trace devices used to show the interface between the wedges of the SPECIAL REUSABLE ANCHOR 31 and the structure being connected.

FIGS. 20A through 20D are sketches of the SPECIAL REUSABLE ANCHOR 31 from various views and sketches showing features.

FIG. 21 is one of the early design sketches of the SPECIAL REUSEABLE ANCHOR 31.

### DESCRIPTION OF THE DRAWINGS—REFERENCE NUMERALS

The following list refers to the drawings:
31 general assembly of the device
32 general fastener
32A general fastener shoulder
32B general fastener threads
33 free wedge with an aperture
34 threaded wedge
35 nut/threaded connection
36 washer
37 free wedge—45 degree
38 threaded wedge 45 degree
39 free wedge 30 degree
40 trapezoidal wedge 60 degree
41 threaded wedge 30 degree
42 eyelet fastener
43 hook fastener
44 hex head fastener
45 slot head fastener
46 phillips head fastener
47 external torques head fastener
48 internal torques head fastener
49 general knurl
50 diagonal knurl
51 cross knurl
52 spline
53 cross spline
54 diamond knurl
55 angles of various dimensions
56 pressure paper
56A marks of engagement
57 un-engaged spacing
58 engaged off-set
59 aperture of object
60 wood
61 concrete
62 masonry
63 metal
64 structure
65 partial engagement
66 full engagement
67 hanging method such as a hand or cable
68 mark of the footprint of a structure
ODA outer diameter of anchor body
TIDA thread internal diameter of anchor
ODFT thread diameter of general fastener 32B
ID-O internal diameter of aperture 59 in object 64

### DETAILED DESCRIPTION OF PREFERRED EMBODIMENT

The present device is a mechanism for a person to anchor an object to another structure called a SPECIAL REUSABLE ANCHOR 31. The preferred embodiment of the device is comprised of several structural members namely a fastener with various top portions or “heads”; one or more free wedge portion with a non-threaded aperture; and, a threaded wedge means for securing and connecting the SPECIAL REUSABLE ANCHOR to a structure. While the main members are capable of securely connecting various objects to other objects or structures, the overall device has a means to release and reuse the SPECIAL REUSABLE ANCHOR for other connections without significant damage to the object or structure.

The improvement over the existing art is providing a device that:
a. is re-usable;
b. is non-destructive;
c. is a combination of simple mechanisms;
d. provides an Economy of scale for component parts;
e. is durable and strong;
f. allows for various angle interfaces; and
g. is adaptable to current connection protocol

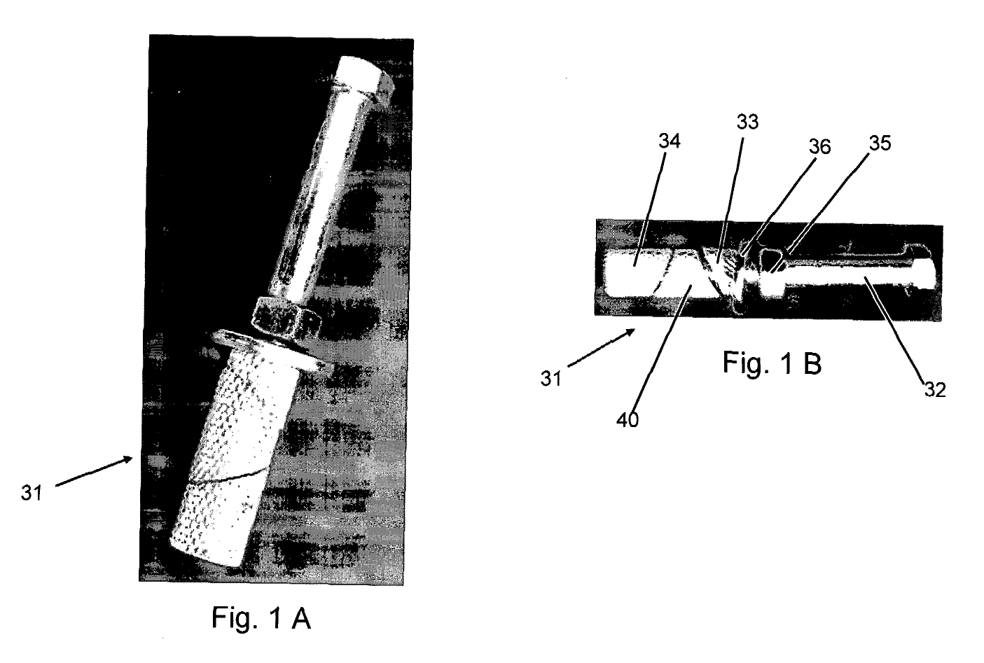

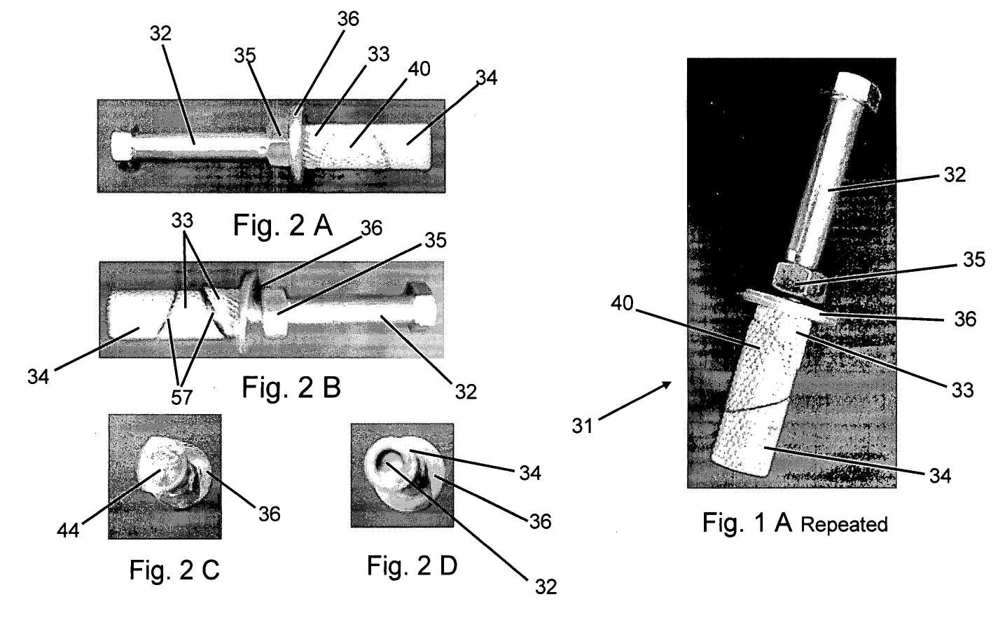

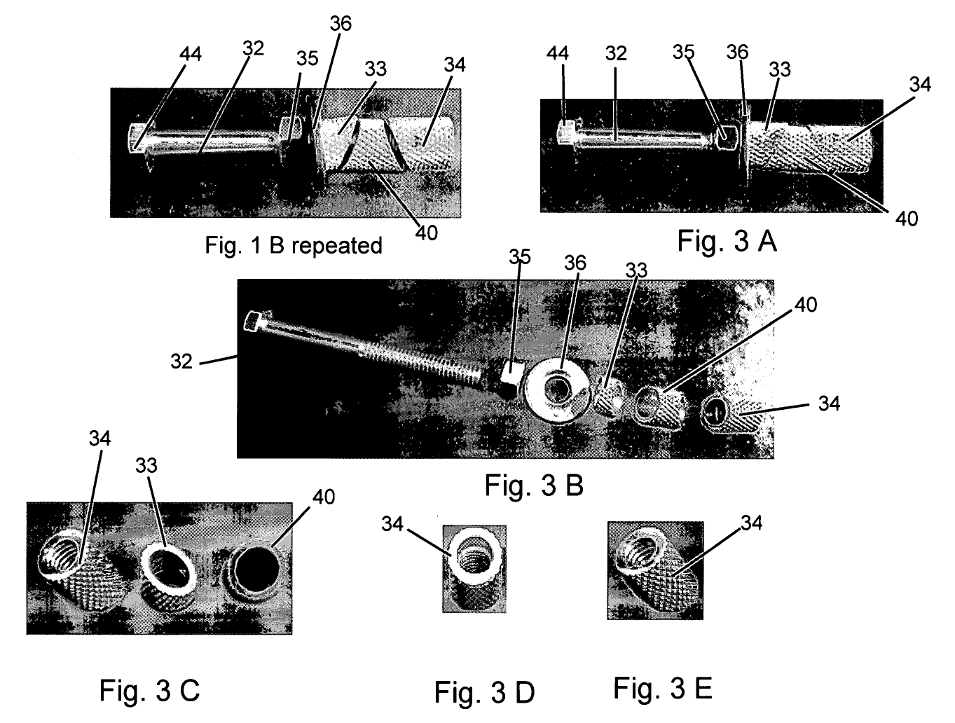

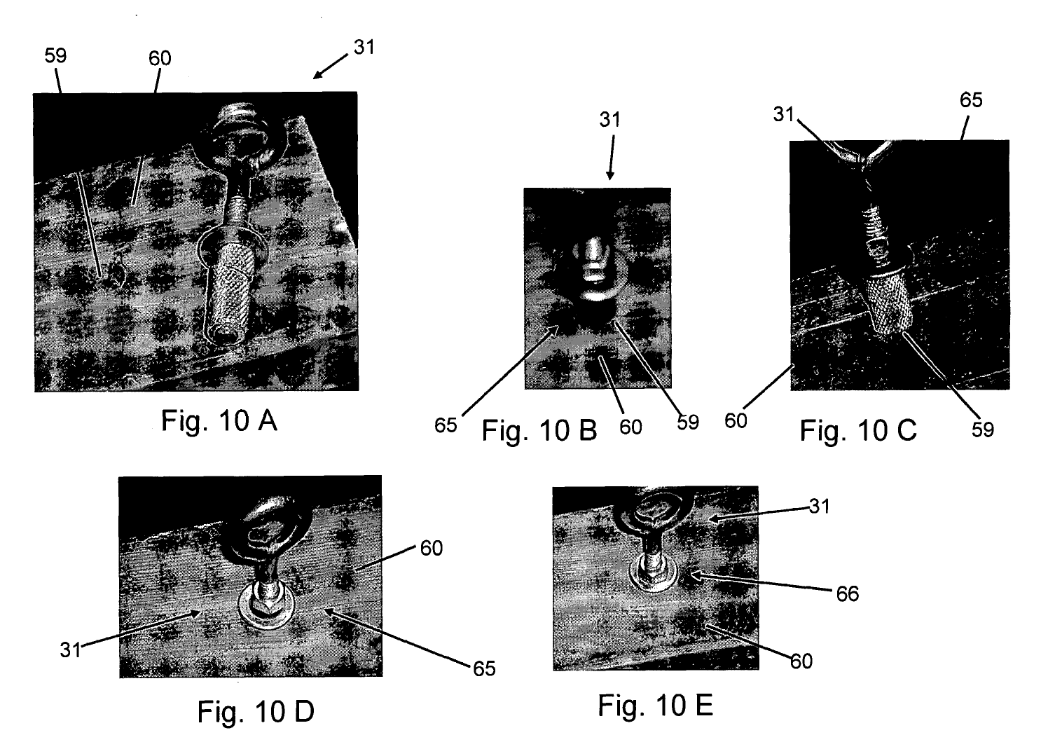

There is shown in FIGS. 1 through 21 a complete description of the operative embodiment of the SPECIAL REUSABLE ANCHOR 31. In the drawings and illustrations, one notes well that the FIGS. 1 through 9 and FIG. 19 through FIG. 21 demonstrate the general configuration of this invention. The FIGS. 10 through 18 show the operation of the embodiment. The preferred embodiment of the device is comprised of only a few parts as shown in the drawings. These structural members or parts include, but are not limited to, a fastener 32 with various top portions or “heads” 42 to 48; a free wedge portion 33 with a non-threaded aperture; and, a threaded wedge 34 means for securing and connecting the SPECIAL REUSABLE ANCHOR 31 to a structure. While the three main members are securely connected to the structure 64, the overall device has a means to release and reuse the SPECIAL REUSABLE ANCHOR 31 for other connections without significant damage to the structure 64.

The accompanying drawings, which are incorporated in and constitute a part of this specification, illustrate an embodiment of the SPECIAL REUSABLE ANCHOR 31 that is preferred. The drawings together with the summary description given above and a detailed description given below serve to explain the principles of the SPECIAL REUSABLE ANCHOR 31. It is understood, however, that the SPECIAL REUSABLE ANCHOR 31 is not limited to only the precise arrangements and instrumentalities shown.

FIGS. 1A and B are Photographs of a prototype assembly of the SPECIAL REUSABLE ANCHOR device 31. The general configuration of the SPECIAL REUSABLE ANCHOR 31 is shown in FIG. 1A. Details of components are explained in FIG. 1B. The main fastener 32 has a nut or threaded device 35 and a spacer or washer 36. The fastener 32 has an elongated shaft and a diameter with various engagement features or heads at one end and threads at the opposite end. Additionally there is at least one free wedge 33 with a non-threaded aperture and a threaded wedge 34. The free tubular-like wedge 33 has a free and non-threaded internal aperture. The free wedge 33 has a surface inclined at an angle, such as 30, 45, or 60, at one end and a surface essentially flat and placed perpendicular to the shaft of the fastener 32 and contiguous to the flat washer 36 at the opposite end. The free wedge 33 has a roughened outside surface 49. The threaded wedge 34 is an internally threaded tubular-like wedge with an aperture. The threaded wedge 34 has a surface inclined at an angle (which matches with the free wedge such a 60, 45, or 30 degree respectively) at one end placed contiguous to the inclined surface of the free wedge 33 and a flat surface at the opposite end, and the threaded wedge having a roughened outside surface 49. Depending on the specific configuration there may be more free wedges such as the trapezoidal wedge 40 shown here. One skilled in the art of fastener devices appreciates that the “threads” may be fine, coarse or even a special configuration and remain well within the scope and spirit of the SPECIAL REUSABLE ANCHOR device 31. Likewise, the thickness of the wall of the threaded device 34 (between the threaded aperture and the external surface) may vary. Finally, the overall outer diameter of the anchor 31 and threads of the fastener 32 may vary in size and still be within the scope of the invention. For example, threads 32 of a nominal 5/16 or smaller to ½ to 1.0 to 2.0 inches or larger, etc are contemplated within the spirit. Anchor diameters ODA of ⅜ or smaller to 4 inches or larger are contemplated. In other words, the same concept of the wedges of the anchor 31 forced apart along the incline to engage the aperture 59 of the structure 64 works in various dimensions for a given anchor 31 size and aperture in the structure.

FIG. 2A through 2D are photographs of the SPECIAL REUSABLE ANCHOR device 31 with the various components noted. FIG. 1A is repeated for reference. In FIG. 2A the general fastener 32 is shown with the nut 35, washer 36, free wedges 33 and 40, and threaded wedge 34. FIG. 2B repeats these components with the open, un-engaged condition 57 shown. FIG. 2C shows a top view of the fastener, here with a hex head 44. Then, FIG. 2D shows a bottom view depicting the general fastener 32 engaged with the threaded wedge 34.

FIG. 3A through 3E are photographs of the SPECIAL REUSABLE ANCHOR device 31 with the various components of the anchor noted. Again a reference view FIG. 1B is repeated. FIG. 3A show another SPECIAL REUSABLE ANCHOR 31 with its components explained. The hex head 44, general fastener 32, nut 35, washer 36, free wedges 33 and 44, and threaded wedge 34 are depicted. In FIG. 3B, these same components are shown in a disengaged position. Then in FIGS. 3C through E the wedges 33, 34, and 40 are displayed.

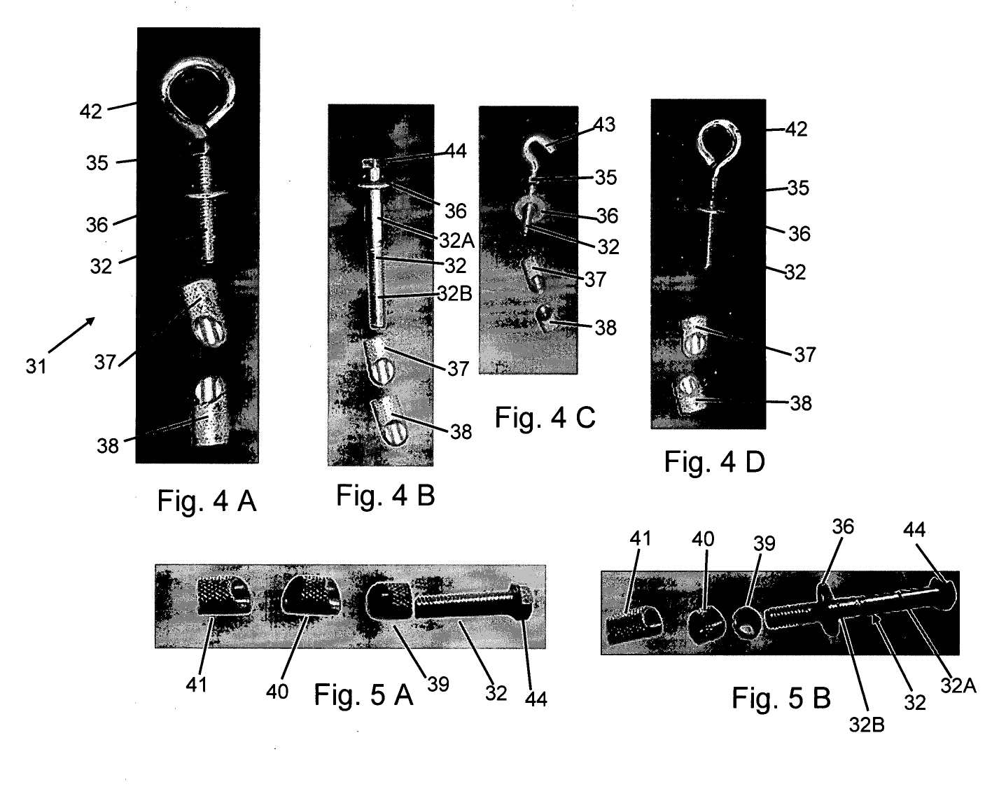

FIGS. 4A through 4D are examples of the SPECIAL REUSABLE ANCHOR 31 in various configurations. FIG. 4A shows the SPECIAL REUSABLE ANCHOR 31 with an eyelet 42. The similar other components nut 35, washer 36, general fastener portion 32 connect with the wedges. Here a two piece wedge shows an approximately 45 degree free wedge 37 and a 45 degree threaded wedge 38. One skilled in the art appreciates other wedge angles may work as well. For another example and not as a limitation one may use an approximately 30 degree wedge coupled with a 60 degree wedge to accomplish the interface. A plethora of other combinations may be used within the spirit of the invention stated herein. Further in FIG. 4B, a hex head 44 for the SPECIAL REUSABLE ANCHOR 31 is shown. Also, this view depicts the further features of the general fastener 32 which shows a shoulder 32A portion and threaded portion 32B. Each fastener 32 has at least three distinct options of the threaded portion, the shoulder (if any) and the type of head. Various heads include, but are not limited to a hex head 44, an eyelet 42, a hook 43, a slot head 45 (not shown), a Phillips/cross slot 46 (not shown), and internal 48 and external 47 torques heads (not shown). FIG. 4C shows a hook 43 and FIG. 4D shows an eyelet 42 option.

FIGS. 5A and B are photographs of an alternative embodiment of the SPECIAL REUSABLE ANCHOR 31 and its components. Here the three piece wedge assembly 39, 40, and 41 are shown with a fully threaded fastener 32 in FIG. 5A and an alternative showing a shouldered 32A fastener 32. Either of the embodiments with a given object is effective and reusable.

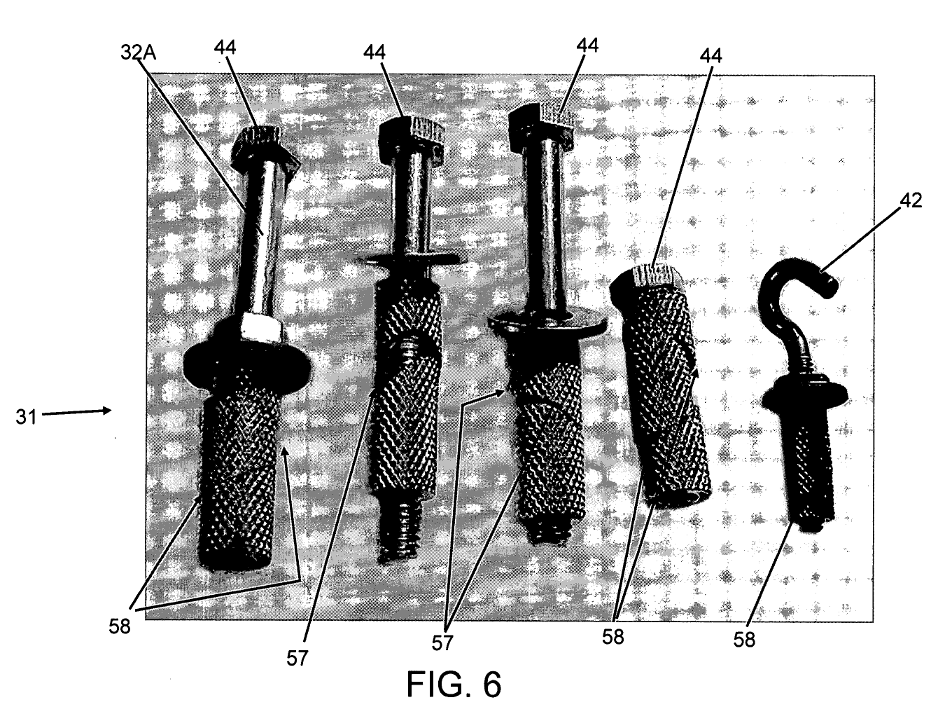

FIG. 6 is a photograph of additional alternative embodiments of the SPECIAL REUSABLE ANCHOR 31. Importantly denoted in this view are the instances of fully engaged conditions 58 and partially engaged 57. Once engaged, the wedges are forced to interfere with the accepting structure 64 and create a holding force. This interference is created for all types of fasteners 32 and receiving structures 64. One skilled in the art of fasteners and anchors well appreciates that the SPECIAL REUSABLE ANCHOR 31 may be made of various materials such as metal (aluminum, steel, brass, copper, and the like), composite materials (plastics—reinforced and virgin, graphite, etc) and other materials. Equally important is that these devices may be case hardened, plated, or coated with various materials to permit them to have longer wear and be more durable in use.

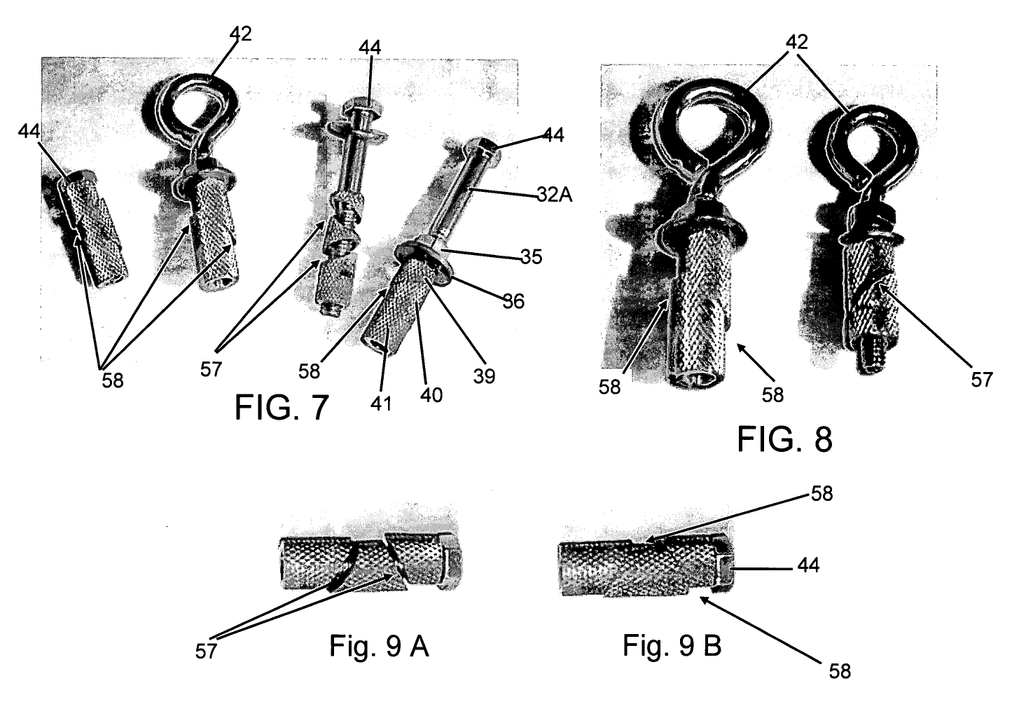

FIG. 7 is another photograph showing the additional alternative embodiments of the SPECIAL REUSABLE ANCHOR 31. Importantly, these views depict the SPECIAL REUSABLE ANCHOR 31 in an engaged position 58 where the wedges 39, 40, and 41 create the interference between the anchor 31 and structure 64 (not shown) that creates the releasable connection. Further views in this FIG. 7 depict the fasteners 31 in the open position 57 with the resulting in non-engagement.

FIG. 8 is a photograph showing the detailed components for the two piece and three piece wedges for the SPECIAL REUSABLE ANCHOR 31. Here a device with an eyelet 42 is shown in the non-engaged 57 and engaged 58 positions.

FIGS. 9A and B are photographs of the SPECIAL REUSABLE ANCHOR 31 as the wedges are non-engaged 57 with open spaces FIG. 9A. In FIG. 9B, the engaged position 58 is shown where the SPECIAL REUSABLE ANCHOR 31 has been tightened down and the wedges a re forced apart creating an interference that holds the anchor 31 to the structure 64 (not shown).

FIGS. 10 through 18 are described below in the operative portion of the description for the SPECIAL REUSABLE ANCHOR 31.

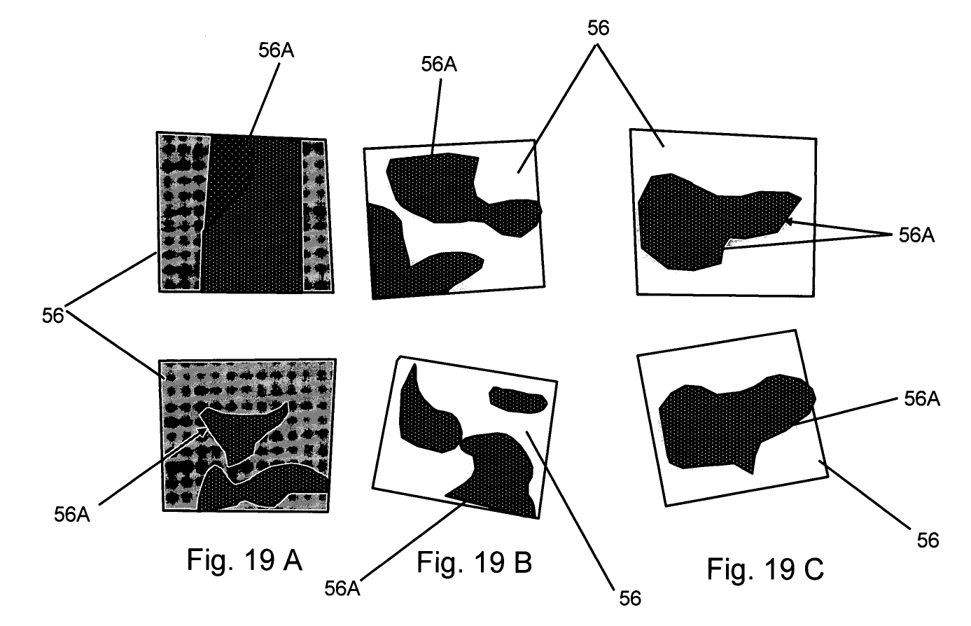

FIGS. 19A through 19C are sketches replicating photographs of pressure trace devices used to show the interface between the wedges of the SPECIAL REUSABLE ANCHOR 31 and the structure being connected. One skilled in the art of fasteners and machining techniques appreciates the manner to validate engagement with the use of pressure paper 56. Here with several views one sees the engagement marks 56A or footprint of the SPECIAL REUSABLE ANCHOR 31 device into the receiving structure 64 (not shown). The marks 56A indicate significant interference shown which in turn demonstrates that the SPECIAL REUSABLE ANCHOR 31 has significant holding force. The actual force for various sized SPECIAL REUSABLE ANCHOR 31 can be easily determined by simple empirical confirmation testing. One skilled in the art of testing fastener well appreciates that the capability of the anchor 31 is dependent on the size of the fastener 32, the material of the anchor 31 and structure 64, and the torque of the fasteners 32 engagement into the structure 64. Other factors are the type of knurl 49 or external surface of the wedges as discussed below.

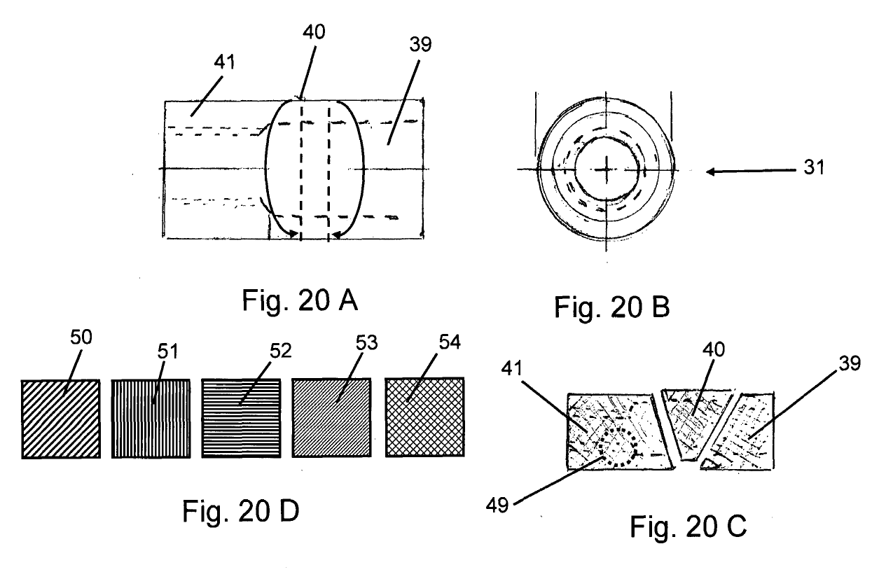

FIGS. 20A through 20D are sketches of the SPECIAL REUSABLE ANCHOR 31 from various views and sketches showing features. FIGS. 20A through 20C are a side sketch, end sketch and separated side sketch, respectively, that show typical views of the three piece wedge combination including a free wedge 39, a trapezoidal free wedge 40, and a threaded wedge 41 for a general SPECIAL REUSABLE ANCHOR 31. In the FIG. 20D examples of external configurations of the wedges are shown. Here the various types are exemplary and not limiting. One skilled in finishing and interference configurations well appreciates the plethora of various mechanical configurations to the wedges that are possible. This concept does not limit the scope by the examples show. However, specific examples shown in FIG. 20D include a diagonal knurl 50, a cross knurl 51, a spline 52, a cross spline 53, and a diamond knurl 55. One remembers that these fastener devices may be case hardened, plated, or coated with various materials to permit them to have longer wear and be more durable in use.

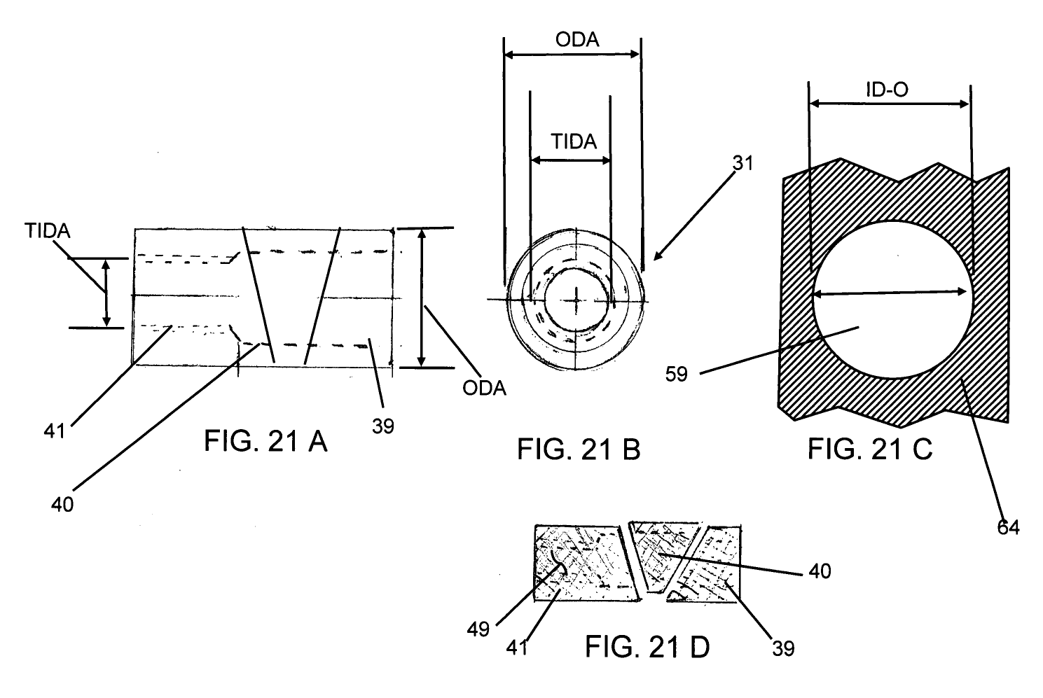

FIG. 21A through 21D are some of the early design sketches of the SPECIAL REUSABLE ANCHOR 31. There is a side sketch, end sketch, separated side sketch, and object 60 with aperture 59 respectively, that show typical views of the three piece wedge combination. These pieces include a free wedge 39, a trapezoidal free wedge 40, and a threaded wedge 41 for a general SPECIAL REUSABLE ANCHOR 31. In addition the diameters of several of the features of the anchor 31 and object 60 are shown. The general outer diameter ODA of the knurled anchor is delineated. The inner diameter of the threaded portion of the anchor TIDA is also shown in the views. For the aperture 59 of the general object 60, the inner diameter of the object ID-O is also shown. Important to note is that the knurled outer anchor diameter ODA is “slightly smaller” than the inner diameter ID-O of the aperture of the object. For example and not as a limitation, the outer diameter of the anchor ODA may be “0.490±0.004 inches” and the inner diameter of the object ID-O is “0.500+0.004/−0.00 inches”. The example of the tolerance will vary with the nominal diameter of the anchor as it increases and decreases. The object of this variation of tolerances is to allow for a snug clearance of the anchor 39 into the aperture 59 of the object.

To engage the anchor 31 with the object 60, the fastener 32 is turned to engage the threads TIDA of the anchor 31. This engagement is accomplished when the threads of the fastener ODFT engage the internal threads of the anchor TIDA and encourage and force the threaded wedge 41 to toward the trapezoidal free wedge 40 and the free wedge 39. This movement in turn shifts the free wedges 40, 39 away from the fastener and creates the holding force of the anchor 31 onto the internal surface of the aperture 59 of the object 60. Thus, the object 60 is secured to the anchor 31.

The details mentioned here are exemplary and not limiting. Other specific components specific to describing a SPECIAL REUSABLE ANCHOR 31 may be added as a person, having ordinary skill in the field of anchor devices, well appreciates.

### Operation of the Preferred Embodiment

The new SPECIAL REUSABLE ANCHOR 31 has been described in the above embodiment. The manner of how the device operates is described below. One notes well that the description above and the operation described here must be taken together to fully illustrate the concept of SPECIAL REUSABLE ANCHOR 31. In FIGS. 10 through 18 and FIG. 21 the operation of the preferred and alternative embodiments are shown.

FIGS. 10A through E are photographs of a SPECIAL REUSABLE ANCHOR 31 with an eyelet 42 showing attachment to a wood structure. In FIG. 10A, the general SPECIAL REUSABLE ANCHOR 31 is shown adjacent to the aperture 59 on the wood structure 60. Next in the FIG. 10B the SPECIAL REUSABLE ANCHOR 31 is partially engaged 65 into the aperture 59 of the wood structure 60. In FIGS. 10C and 10D additional views of the partial engagement 65 are depicted. Finally, in FIG. 10 E, a fully engaged 66 view of the SPECIAL REUSABLE ANCHOR 31 is shown in the wood structure 60.

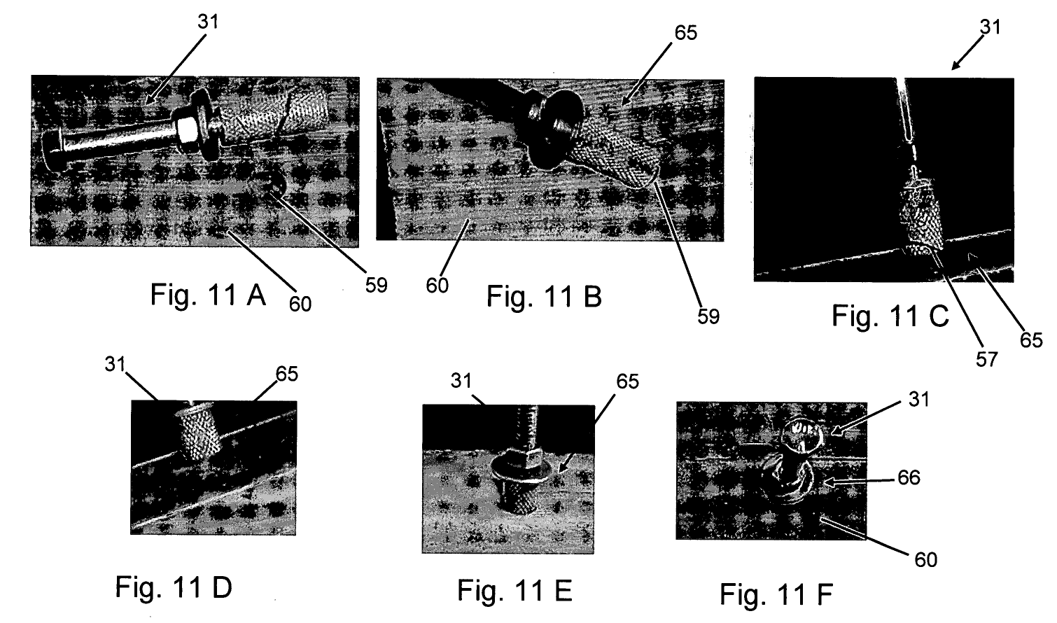

FIGS. 11A through F are photographs of a SPECIAL REUSABLE ANCHOR 31 with a hex head bolt 44 showing attachment to a wood structure 60. In FIG. 11A, the general SPECIAL REUSABLE ANCHOR 31 is shown adjacent to the aperture 59 on the wood structure 60. Next in the FIG. 11B the SPECIAL REUSABLE ANCHOR 31 is partially engaged 65 into the aperture 59 of the wood structure 60. In FIGS. 11C, 11D and 11E additional views of the partial engagement 65 are depicted. Finally, in FIG. 11F, a fully engaged 66 view of the SPECIAL REUSABLE ANCHOR 31 is shown in the wood structure 60.

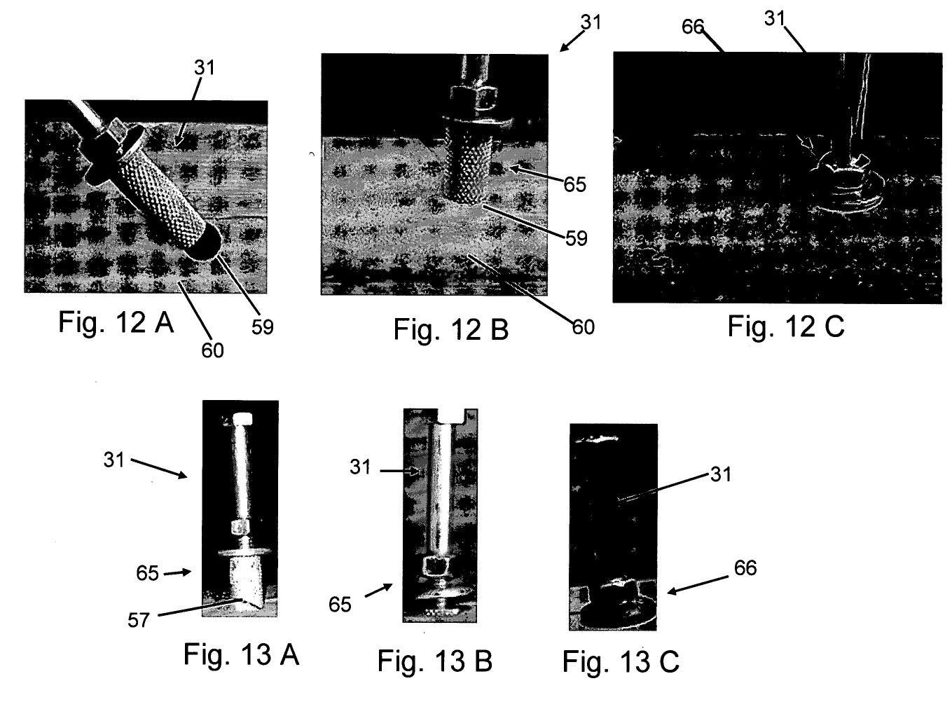

FIGS. 12A through C are photographs of the preferred embodiment of the SPECIAL REUSABLE ANCHOR device 31 in its full operation. Again, in FIG. 12A, the general SPECIAL REUSABLE ANCHOR 31 is shown adjacent to the aperture 59 on the wood structure 60. Next in the FIG. 12B the SPECIAL REUSABLE ANCHOR 31 is partially engaged 65 into the aperture 59 of the wood structure 60. Finally, in FIG. 12C, a fully engaged 66 view of the SPECIAL REUSABLE ANCHOR 31 is shown in the wood structure 60.

FIGS. 13A, 13B, and 13C are close-up photographs of the SPECIAL REUSABLE ANCHOR 31 in operation. In FIGS. 13A and 13B the general SPECIAL REUSABLE ANCHOR 31 is shown partially engaged 65 into the aperture 59 of the wood structure 60. In FIG. 13C a fully engaged 66 view of the SPECIAL REUSABLE ANCHOR 31 is shown in the wood structure 60.

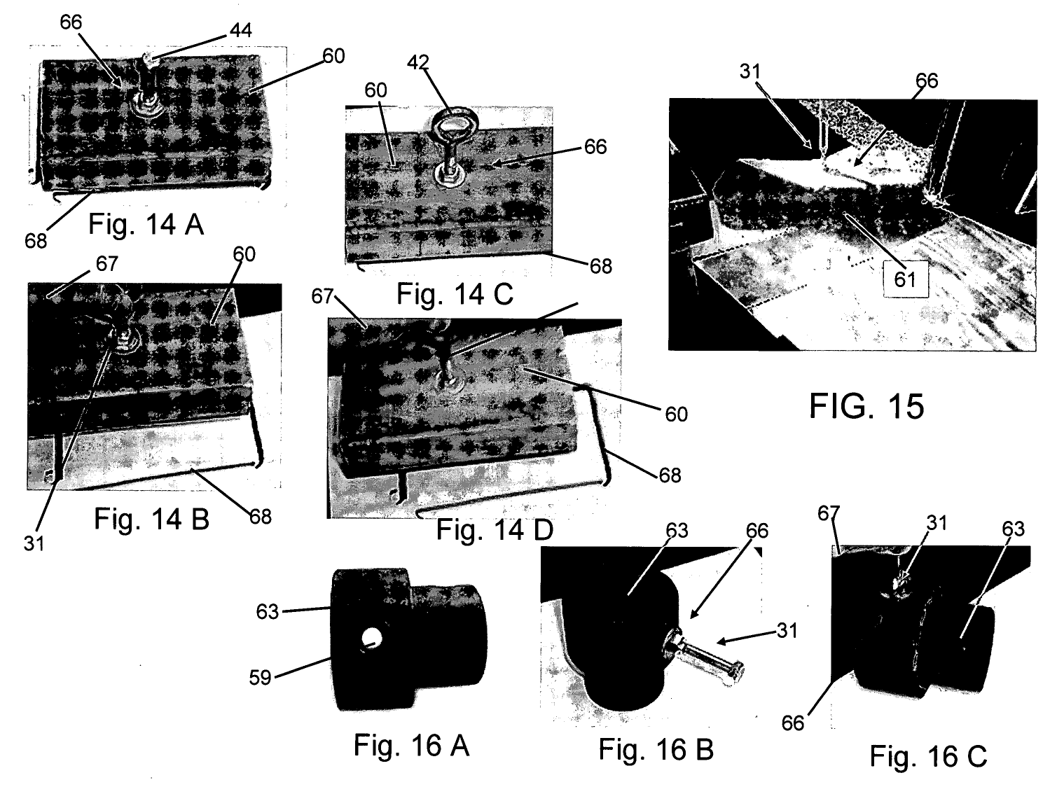

FIGS. 14A through 14D are photographs of an operation of an embodiment for a SPECIAL REUSABLE ANCHOR 31 attached to a wood structure 60. In FIG. 14A and FIG. 14C a hex head 44 and eyelet 42 type of the SPECIAL REUSABLE ANCHOR 31 is shown fully engaged 66 into the wood structure 60. A footprint mark 68 is also denoted. Next, in views FIGS. 14B and 14D, the devices 31 are raised by the method 67 and shown above the footprint mark 68 in both views.

FIG. 15 is a photograph of a SPECIAL REUSABLE ANCHOR 31 supporting a concrete structure 61. Here the SPECIAL REUSABLE ANCHOR 31 is fully engaged 66 into the concrete 61 and supports the structure totally.

FIGS. 16A through 16C are photographs of an operation of an embodiment for a SPECIAL REUSABLE ANCHOR 31 attached to a metal structure 63. In FIG. 16A, the structure 63 and aperture 59 are depicted. Next in FIGS. 16B and C, the SPECIAL REUSABLE ANCHOR 31 are shown fully engaged 66 into the metal structure 66. Finally, in FIG. 16C, the metal structure 63 is suspended by some means 67 by the SPECIAL REUSABLE ANCHOR 31.

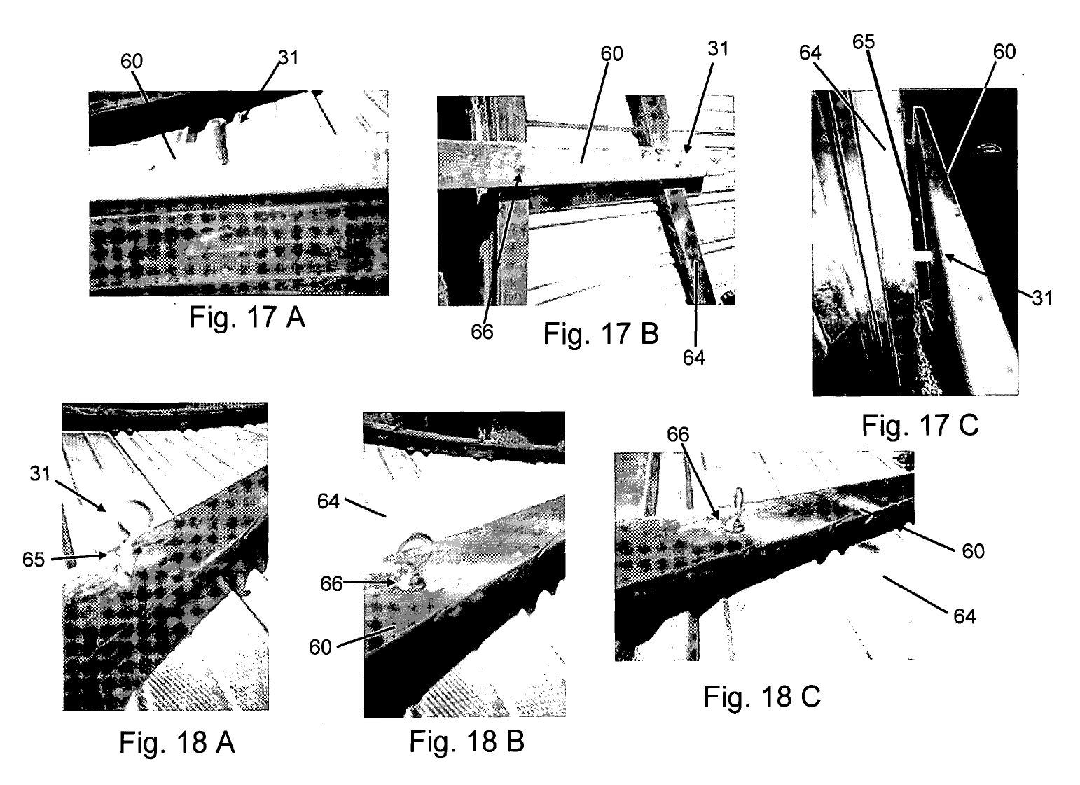

FIGS. 17A through 17C are photographs of an operation of an embodiment for a SPECIAL REUSABLE ANCHOR 31 attached to a wood structure 60 on a door and door support. Sown in these views are the SPECIAL REUSABLE ANCHOR 31 either partially 65 or fully 66 engaged. Demonstrated clearly are methods to easily use the SPECIAL REUSABLE ANCHOR 31 in common construction events. The anchor 31, while revolutionary, can be easily and simply adapted to other building needs currently used.

FIGS. 18A through 18C are photographs of several views of another operation of an embodiment for a SPECIAL REUSABLE ANCHOR 31 attached to a wood structure 60 on a door cross support. This is an additional example of the ease of use for the SPECIAL REUSABLE ANCHOR 31 in common construction practices.

TABLE A
Examples of Uses (not as a limitation)

| Item | Description of Use - Attach Objects to |
|---|---|
| 1 | Walls |
| 2 | Ceilings |
| 3 | Floors |
| 4 | Support piers and the like |
| 5 | Other Objects |
| 6 | Frames along widows and doors to accept hurricane |
| | covers to be removed after the storm or season passes |

Example (not as a limitation) of tolerances for the SPECIAL REUSABLE ANCHOR 31 are shown in FIG. 21 and in the following Table. An example of the engagement of this example is described above.

TABLE B
Examples of Tolerances between anchor 31 and
aperture 59.

| ITEM | DESCRIPTION | Example |
|---|---|---|
| ODA | Outer Diameter of the | 0.490 +/− .004 inches |
| | anchor 31 | |
| ID-O | internal diameter of | .500 + .004/−0.00 inches |
| | aperture 59 in object 60 | |
| ODFT | thread diameter of | 5/16–18 UNC 2B |
| | general fastener 32B | |
| TIDA | Internal thread diameter | 5/16–18 UNC 2B |
| | of the fastener | |

With this description it is to be understood that the SPECIAL REUSABLE ANCHOR 31 is not to be limited to the disclosed embodiment. The features of the SPECIAL REUSABLE ANCHOR 31 are intended to cover various modifications and equivalent arrangements included within the spirit and scope of the description.

What is claimed as new and desired to be protected by Letters Patent is:

1. A reusable anchor device for removably securing the anchor device to an essentially solid structure that has an aperture, the anchor device made with a durable material and comprising:
(a) a fastener with an elongated shaft and a diameter with various engagement features at one end and threads at the opposite end;
(b) a nut with internal threads;
(c) an essentially flat washer;
(d) a free tubular-like wedge with a non-threaded internal aperture, the free wedge having a surface inclined at an angle at one end and a surface essentially flat and placed perpendicular to the shaft of the fastener and contiguous to the flat washer at the opposite end, and the free wedge having a roughened outside surface; and
(e) an internally threaded tubular-like wedge with an aperture, the threaded wedge having a surface inclined at an angle at one end placed contiguous to the inclined surface of the free wedge and a flat surface at the opposite end, and the threaded wedge having a roughened outside surface;
whereby the anchor device is removably installable into the aperture of the structure such that the structure is rigidly secured to the anchor.

2. The device according to claim 1 wherein the durable material is metal.

3. The device according to claim 2 wherein the metal is aluminum.

4. The device according to claim 2 wherein the metal is steel.

5. The device according to claim 2 wherein the metal is bronze.

6. The device according to claim 1 wherein the material is a composite material.

7. The device according to claim 2 wherein the composite material is plastic.

8. The device according to claim 1 wherein the engagement feature of the fastener is a hex-head.

9. The device according to claim 1 wherein the engagement feature of the fastener is an eyelet.

10. The device according to claim 1 wherein the engagement feature of the fastener is a hook.

11. The device according to claim 1 wherein the roughened outside surface of the free and threaded wedges is a diamond knurl.

12. The device according to claim 1 wherein the roughened outside surface of the free and threaded wedges is a straight spline.

13. The device according to claim 1 wherein the roughened outside surface of the free and threaded wedges is a coating with a means to grip.

14. The device according to claim 13 wherein the means to grip is an elastomeric material.

15. The device according to claim 1 wherein the inclined angle on the free wedge is approximately 45 degrees to the shaft of the fastener and the inclined angle on the threaded wedge is approximately 45 degrees to the shaft of the fastener.

16. The device according to claim 1 wherein the inclined angle on the free wedge is approximately 60 degrees to the shaft of the fastener and the inclined angle on the threaded wedge is approximately 30 degrees to the shaft of the fastener.

17. A reusable anchor device for removably securing the anchor device to an essentially solid structure that has an aperture, the anchor device made with a durable material and comprising:
(a) a fastener with an elongated shaft and a diameter with various engagement features at one end and threads at the opposite end;
(b) a nut with internal threads;
(c) an essentially flat washer;
(d) a free tubular-like wedge with a non-threaded internal aperture, the free wedge having a surface inclined at an angle at one end and a surface essentially flat and placed perpendicular to the shaft of the fastener and contiguous to the flat washer at the opposite end, and the free wedge having a roughened outside surface;
(e) one or more trapezoidal-like free tubular wedges with a non-threaded internal aperture, the trapezoidal free wedge having end surfaces inclined at an angle and contiguous to the free wedge at one end, and the trapezoidal wedge having a roughened outside surface; and
(f) an internally threaded tubular-like wedge with an aperture, the threaded wedge having a surface inclined at an angle at one end placed contiguous to the inclined surface of the trapezoidal wedge and a flat surface at the opposite end, and the threaded wedge having a roughened outside surface;
whereby the anchor device is removably installable into the aperture of the structure such that the structure is rigidly secured to the anchor.

18. A reusable anchor device for removably securing the anchor device to an essentially solid structure that has an aperture, the anchor device made with a metal material and comprising:
(a) a fastener with an elongated shaft and a diameter with a hex-head engagement features at one end and threads at the opposite end;
(b) a nut with internal threads;
(c) an essentially flat washer;
(d) a free tubular-like wedge with a non-threaded internal aperture, the free wedge having a surface inclined at a 45 degree angle at one end and a surface essentially flat and placed perpendicular to the shaft of the fastener and contiguous to the flat washer at the opposite end, and the free wedge having a diamond knurled outside surface;
(e) a trapezoidal-like free tubular wedges with a non-threaded internal aperture, the trapezoidal free wedge having end surfaces inclined at opposite 45 degree angles and contiguous to the free wedge at one end, and the trapezoidal wedge having a diamond knurled outside surface; and
(f) an internally threaded tubular-like wedge with an aperture, the threaded wedge having a surface inclined at a 45 degree angle at one end placed contiguous to the inclined surface of the trapezoidal wedge and a flat surface at the opposite end, and the threaded wedge having a diamond knurled outside surface;
whereby the anchor device is removably installable into the aperture of the structure such that the structure is rigidly secured to the anchor.
